(19) United States
(12) Patent Application Publication
(10) Pub. No.: US 2025/0278655 A1
(43) Pub. Date: Sep. 4, 2025

(54) CONTROL PULSE DISTORTION COMPENSATION USING REFLECTION PARAMETERS FROM STANDING WAVE ANALYSIS

(71) Applicant: Google LLC, Mountain View, CA (US)

(72) Inventors: Benjamin Thomas Chiaro, Goleta, CA (US); Yaxing Zhang, Santa Barbara, CA (US); Kenneth William Lee, Santa Barbara, CA (US)

(21) Appl. No.: 18/791,972

(22) Filed: Aug. 1, 2024

Related U.S. Application Data
(60) Provisional application No. 63/560,347, filed on Mar. 1, 2024.

(51) Int. Cl. G06N 10/40; G06N 10/20; G06N 10/60; G06N 10/70

(52) U.S. Cl. CPC G06N 10/40; G06N 10/20; G06N 10/60; G06N 10/70

(57) ABSTRACT

Methods, systems and apparatus for microwave pulse distortion compensation using reflection parameters from standing wave analysis. In one aspect, a method includes generating a pre-distorted control signal that implements a single qubit rotation operation and applying the pre-distorted control signal to a qubit to perform the rotation operation on the qubit, the pre-distorted control signal comprising an inverted transfer function. The inverted transfer function comprises values of parameters obtained through fitting control pulse amplitudes that implement a full qubit population transfer to a reflection model with reflection model parameters that parameterize a standing wave contribution to the control signal that modifies an effective amplitude of control pulses incident on the qubit.

### CROSS-REFERENCE TO RELATED APPLICATIONS

This application claims the benefit under 35 U.S.C. § 119(e) of U.S. Patent Application No. 63/560,347, filed on Mar. 1, 2024. The disclosure of the foregoing application is incorporated herein by reference in its entirety for all purposes.

### BACKGROUND

This specification relates to quantum computing.

Classical computers have memories made up of bits, where each bit can represent either a zero or a one. Quantum computers maintain sequences of quantum bits, called qubits, where each quantum bit can represent a zero, one or any quantum superposition of zeros and ones. Quantum computers operate by setting qubits in an initial state and manipulating the state of the qubits, e.g., according to a sequence of quantum logic gates. A calculation ends with qubit state readout, collapsing the state of the system of qubits into an eigenstate where each qubit represents either a zero or one. The ability to precisely control the state of a collection of quantum bits is a fundamental requirement of a quantum computer.

### SUMMARY

This specification describes technologies for microwave pulse distortion compensation using reflection parameters from standing wave analysis.

In general, one innovative aspect of the subject matter described in this specification can be implemented in a method that includes for each of multiple values of a qubit transition frequency: applying, for each of multiple amplitudes and at the transition frequency, a drive signal with the amplitude to an initialized qubit; and measuring the qubit to obtain measurement data that represents qubit state population after application of the drive signal; extracting, from the measurement data and for each qubit transition frequency in a subset of the multiple values of the qubit transition frequency, a minimal amplitude that corresponds to a full population transfer after application of the drive signal; determining values of parameters of a reflection model to fit the minimal amplitudes to the reflection model, wherein the parameters of the reflection model parameterize a standing wave contribution to the drive signal that modifies an effective amplitude of the drive signal incident on the qubit; inverting a transfer function at the determined values of the parameters of the reflection model, wherein the transfer function corresponds to the reflection model; and pre-distorting one or more control pulses for the qubit using the inverted transfer function.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the parameters of the reflection model comprise a reflection amplitude, round-trip reflection time, and phase shift imparted by reflection.

In some implementations the reflection model comprises an effective amplitude that represents constructive-destructive interference between the drive signal and reflections of the drive signal, wherein the interference creates a standing-wave pattern of voltage in a corresponding transmission line.

In some implementations the reflection model Amp_{π} is given by

$${Amp}_{π} = ( a + b f + c {f}^{2} ) \sqrt{1 + {ϵ}^{2} - 2 ϵ cos ( 2 π {ft}_{0} + {ϕ}_{0} )}$$

where ϵ represents a reflection amplitude, ϕ₀ represents a phase shift imparted by reflection, t₀ represents round-trip reflection time, f represents transition frequency, a+bf+cf² represents a frequency-dependent factor where parameters a, b, c are fitting parameters in the frequency-dependent factor introduced to capture an additional frequency-dependence in the drive signal amplitude.

In some implementations the transition frequency comprises a transition frequency from a ground state to a first excited state and the minimal amplitudes represent a full population transfer from the ground state to the first excited state.

In some implementations determining values of parameters of the reflection model comprises numerically optimizing the values of parameters of the reflection model using the minimal amplitudes.

In some implementations the method further comprises applying the pre-distorted control pulses to the qubit during a quantum computation.

In some implementations the one or more control pulses comprise control pulses that implement rotations about the x axis, y axis, or both the x and y axis.

In some implementations inverting the transfer function at the determined values of the parameters of the reflection model comprises inverting the transfer function in the Fourier domain.

In some implementations pre-distorting a control pulse for the qubit comprises multiplying the inverted transfer function in the Fourier domain by a Fourier transform of the control pulse; and applying an inverse Fourier transform to obtain a pre-distorted control pulse in the time domain.

In some implementations the qubit comprises a transmon qubit and one or more of: the qubit is set to the transition frequency prior to application of the drive signal using a flux bias of a SQUID loop of the transmon qubit; applying the drive signal with the amplitude to the initialized qubit comprises applying the drive signal with the amplitude to a XY control line of the transmon qubit at the transition frequency; and measuring the qubit comprises measuring the ground state population of the transmon qubit with a tone applied to a readout control line of the transmon qubit.

In general, another innovative aspect of the subject matter described in this specification can be implemented in a method performed by a quantum computing device, the method comprising: generating a pre-distorted control signal that implements a single qubit rotation operation; and applying the pre-distorted control signal to a qubit to perform the rotation operation on the qubit, the pre-distorted control signal comprising an inverted transfer function, wherein: the inverted transfer function comprises values of parameters obtained through fitting control pulse amplitudes that implement a full qubit population transfer to a reflection model with reflection model parameters that parameterize a standing wave contribution to the control signal that modifies an effective amplitude of control pulses incident on the qubit.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the parameters of the reflection model comprise a reflection amplitude, round-trip reflection time, and phase shift imparted by reflection.

In some implementations the reflection model comprises an effective amplitude that represents constructive-destructive interference between the drive signal and reflections of the drive signal, wherein the interference creates a standing-wave pattern of voltage in a corresponding transmission line.

In some implementations the reflection model Amp_{π} is given by

$${Amp}_{π} = ( a + b f + c {f}^{2} ) \sqrt{1 + {ϵ}^{2} - 2 ϵ cos ( 2 {π ft}_{0} + {ϕ}_{0} )}$$

where ϵ represents a reflection amplitude, ϕ₀ represents a phase shift imparted by reflection, t₀ represents round-trip reflection time, f represents transition frequency, a+bf+cf² represents a frequency-dependent factor where parameters a, b, c are fitting parameters in the frequency-dependent factor introduced to capture an additional frequency-dependence in the drive signal amplitude.

In some implementations the control pulse amplitudes that implement a full qubit population transfer comprise minimal amplitudes of a drive signal that, when applied to the qubit at respective qubit transition frequencies, implements a full qubit population transfer.

The subject matter described in this specification can be implemented in particular ways so as to realize one or more of the following advantages.

Examples of the presently described control pulse distortion compensation procedure can reduce control error and improve quantum gate fidelity in quantum computing systems.

Further, examples of the presently described control pulse distortion compensation procedure can improve on known methods in several ways. For example, some known control pulse distortion compensation methods only recover parameters for reflections that have round trip times that are relatively long (compared with the pulse length/duration.), e.g., because error amplification sequences are insensitive to short time reflections. However, the presently described techniques can also recover parameters for reflections that have round trip times that are short compared with the pulse length. This is because reflections with round trip times that are short compared to the pulse duration constructively or destructively add to the main driving signal. This addition modifies the effective amplitude of the driving signal and creates an oscillating pattern in the minimal amplitudes of a π pulse (as shown in plot d) of FIG. 4). By fitting to the oscillating pattern with the presently described reflection model, the reflection parameters are recovered. The techniques can therefore be applied to a wider range of experimental systems and devices (systems and devices with both long and short round trip times).

Further, examples of the presently described control pulse distortion compensation procedure can improve on known methods in several ways. For example, some known control pulse distortion compensation methods only recover parameters for reflections that have round trip times that are relatively long (compared with the pulse length/duration.), e.g., because error amplification sequences are insensitive to short time reflections. However, the presently described techniques can also recover parameters for reflections that have round trip times that are short compared with the pulse length. This is because reflections with round trip times that are short compared to the pulse duration constructively or destructively add to the main driving signal. This addition modifies the effective amplitude of the driving signal and creates an oscillating pattern in the minimal amplitudes of a π pulse (as shown in plot d) of FIG. 4). By fitting to the oscillating pattern with the presently described reflection model, the reflection parameters are recovered. The techniques can therefore be applied to a wider range of experimental systems and devices (systems and devices with both long and short round trip times).

Details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example system for microwave pulse distortion compensation.

FIG. 2 is a flow diagram of an example process for generating a pre-distorted control pulse using standing wave analysis.

FIG. 3 is a flow diagram of an example process for performing a quantum computation using pre-distorted control pulses.

FIG. 4 illustrates an example reflection model analysis and compensation procedure.

FIG. 5 depicts an example quantum computing device.

### DETAILED DESCRIPTION

The ability to precisely control the state of a collection of quantum bits is a fundamental requirement of a quantum computer. In many superconducting quantum processor implementations, coherent transformation of the qubit state i.e., logic gates, are enacted by applying pulsed microwave electromagnetic control signals to the qubits. Slight deviations from the intended pulse shape result in imperfect state transformation which is referred to as control error. Microwave pulse distortion is an important source of control error in superconducting qubit systems. Further, reflections arising from impedance discontinuities in the signal chain are a common cause of pulse distortion.

This specification describes techniques for characterizing and compensating pulse distortion in a quantum computing system. Standing wave analysis is used to determine reflection model parameters, which are then used to pre-distort single qubit control pulses such that single qubit gates performed using the pre-distorted control pulses experience less control error and achieve improved gate fidelity.

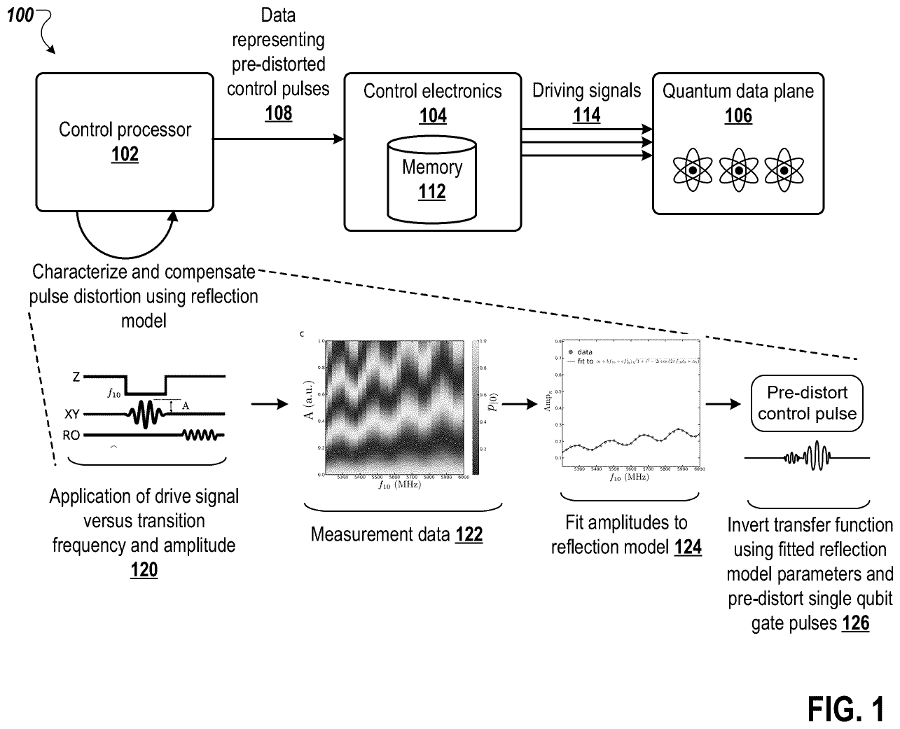

FIG. 1 depicts an example system 100 for microwave pulse distortion compensation. The example system 100 is an example of a system implemented as part of a quantum computing device in which the systems, components and techniques described in this specification can be implemented.

The system 100 includes a control processor 102, control electronics 104, and a quantum data plane 106. In some implementations, some, or all of the components of the example system 100 can be directly connected. In other implementations, some, or all of the components of the example system 100 can be connected through a network, e.g., a local area network (LAN), wide area network (WAN), the Internet, or a combination thereof.

The control processor 102 is a classical processor that can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, one or more qubits, or a combination of one or more of them.

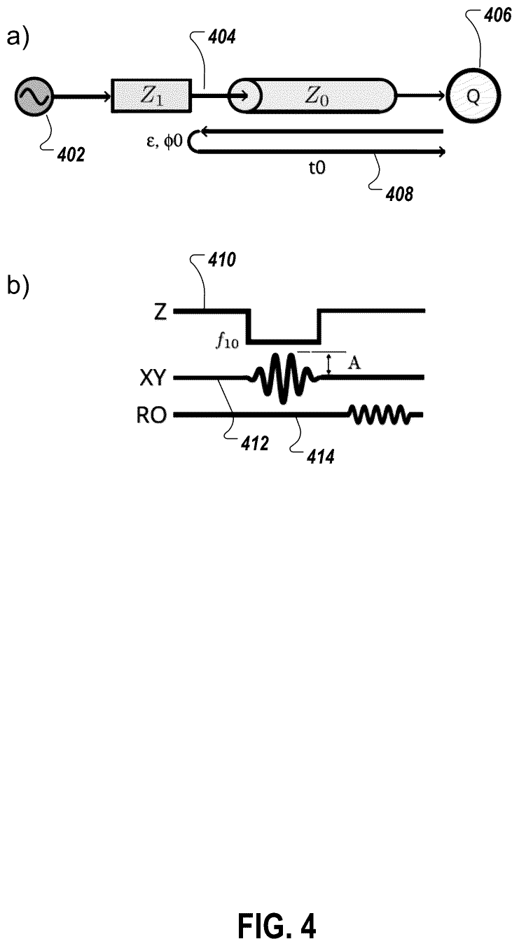

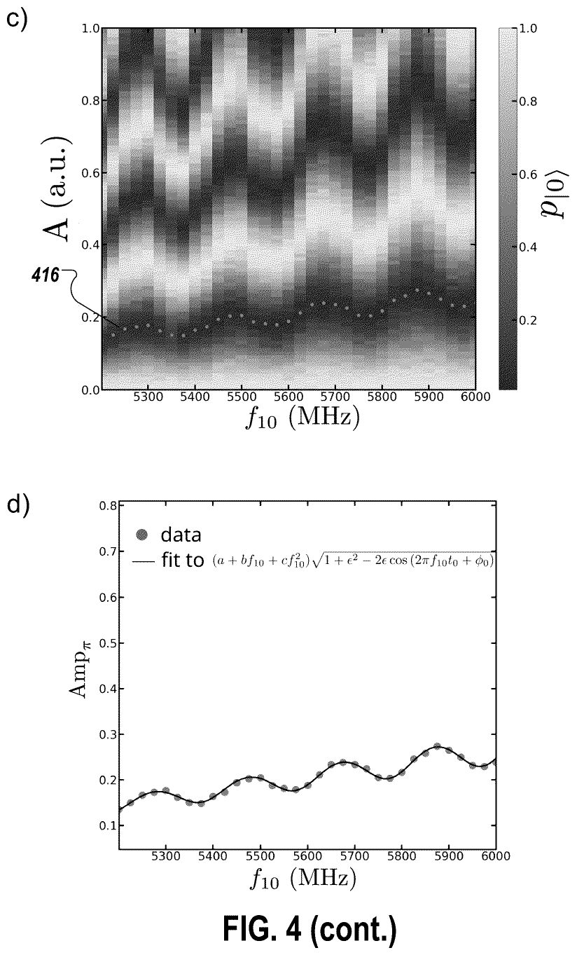

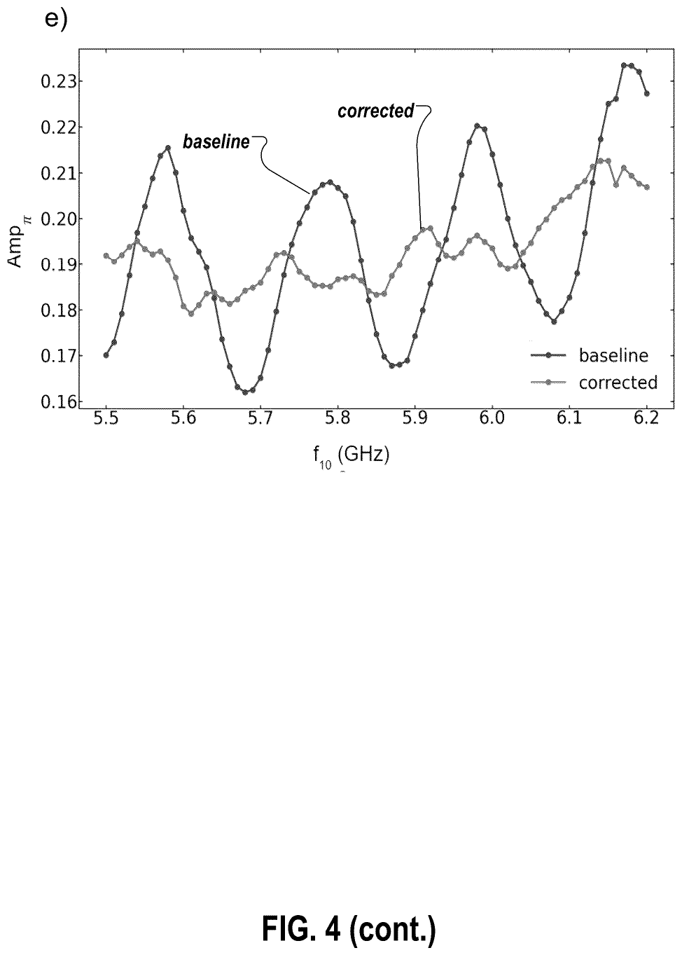

The control processor 102 is configured to perform operations that characterize and compensate pulse distortion in the system 100. For example, to characterize the pulse distortion the control processor 102 is configured to apply a drive signal to a qubit at varying qubit transition frequencies and drive signal amplitudes 120. At each application of the drive signal, a state population, e.g., ground state population, is measured. Measurement data 122 is obtained from the measurements. Minima in the measurement data corresponds to full population transfers, e.g., from |0 [symbol] to |1 [symbol] (which indicates that a π pulse was performed on the qubit.) Example output data obtained at this stage of the characterization procedure is shown and described in more detail below with reference to FIG. 4.

Amplitudes that correspond to first minima on line cuts at constant qubit transition frequency are extracted and fit to a reflection model. In contrast to conventional techniques for pulse distortion compensation, it is not assumed that the period during the control pulses is distortion free and the transfer function is not inferred via an unconstrained, model-free matrix inversion. Instead, it is assumed that the pulse distortion is dominated by a proper subset of reflections present in the system, e.g., a small number of reflections such as three reflections. The control processor 102 therefore fits the extracted amplitudes to a reflection model 124.

The reflection model is designed using standing wave analysis. For example, in some quantum computing devices, e.g., superconducting systems, a qubit can be operated using a signal generator that applies a microwave drive tone to a signal delivery chain that contains an element of impedance Z1 that is mismatched to a transmission line of characteristic impedance Z0, which is also impedance mismatched against the qubit, as illustrated and described below with reference to FIG. 4. These impedance mismatches cause a standing wave that modifies the effective amplitude of control pulses incident on the qubit. Therefore, in the present disclosure the standing wave contribution to the control signal is parameterized by reflection model parameters. The reflection model parameters include a reflection amplitude, round-trip reflection time, and phase shift imparted by reflection.

The reflection model consists of an effective amplitude that results from constructive/destructive interference between the main driving signal and its reflections. Such interference creates a standing-wave pattern of the voltage in the transmission line (e.g., 404 in FIG. 4) where the amplitude of the voltage oscillates as a function of the relative phase between the reflected signal and the main driving signal. The relative phase depends on the frequency of the drive signal, and the round trip time of the reflection (t0 in FIG. 4a), and the phase shift at the reflection interface (ϕ0 in FIG. 4a). The magnitude of the voltage oscillation depends on the reflection amplitude (ε in FIG. 4a). To capture any additional background frequency dependence of the effective drive amplitude (e.g. due to filtering), an additional frequency-dependent factor “a+bf+cf²” is included in the reflection model. That is, in some examples the reflection model can be given by Eq. (1):

$${Amp}_{π} = ( a + b {f}_{10} + c {f}_{10}^{2} ) \sqrt{1 + {ϵ}^{2} - 2 ϵ cos ( 2 π {f}_{10} {t}_{0} + {ϕ}_{0} )} , \qquad ( 1 )$$

where f₁₀ represents the transition frequency, E represents the reflection amplitude, ϕ₀ represents the phase shift imparted by reflection, to represents the round-trip reflection time, and a+bf₁₀+cf₁₀² represents an additional frequency-dependent factor where parameters a, b, c are fitting parameters in the frequency-dependent factor which is introduced to capture the additional frequency-dependence in the π pulse amplitude (e.g. due to filtering).

The control processor is configured to numerically optimize the reflection model parameters by comparing the extracted amplitudes to a predicted pulse distortion generated by the reflection model. To mitigate the reflections, the control processor 102 is configured to invert a transfer function that describes the pulse distortion at values of the optimized reflection model parameters and pre-distort single qubit gate control pulses using the inverted transfer function 126.

The control processor 102 is configured to provide data representing the pre-distorted control pulses 108 to the control electronics 104. The control electronics 104 is configured to convert data received from the control processor 102, e.g., digital signals representing pre-distorted control pulses, to analog driving signals 114 (also referred to herein as control signals) required to perform corresponding single qubit gates on qubits included in the quantum data plane 106. For example, the control electronics 104 can include control devices that operate physical qubits included in the quantum data plane 106. Example control devices include arbitrary waveform generators or control devices that tune frequencies of respective qubits by applying driving signals, e.g., voltage pulses, to the qubits through respective control lines. In some implementations the control electronics 104 can include a memory 112 that is configured to store data, e.g., data specifying pre-defined pre-distorted control pulses generated by the control processor 102.

The quantum data plane 106 includes physical qubits for performing quantum computations. The type of qubits that the quantum data plane 106 utilizes is dependent on the types of computations being performed by the system 100. For example, in some cases the quantum data plane 106 can include one or more resonators attached to one or more superconducting qubits, e.g., Gmon or Xmon qubits. In other cases, the quantum data plane 106 can include ion traps, photonic devices or superconducting cavities. Further examples of realizations of qubits include fluxmon qubits, silicon quantum dots or phosphorus impurity qubits. In some cases, the qubits may be a part of a quantum circuit.

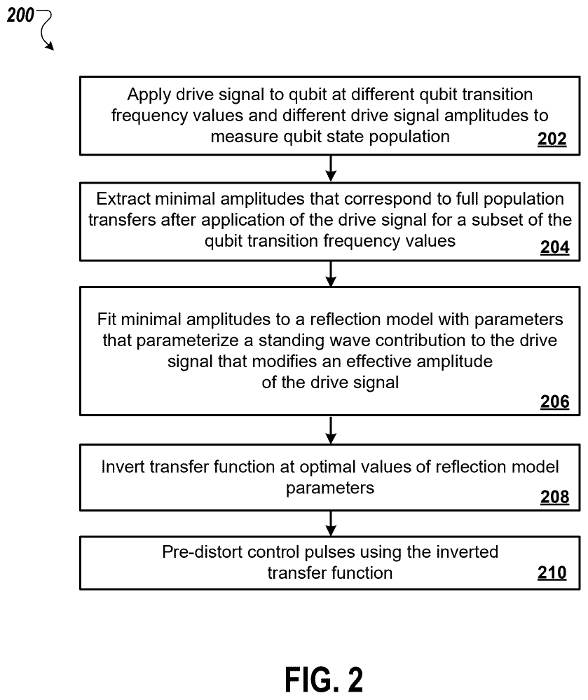

Example operations performed by components of the system 100 are described in more detail below with reference to FIGS. 2-4.

FIG. 2 is a flow diagram of an example process 200 for generating a pre-distorted control pulse using standing wave analysis. For convenience, the process 200 will be described as being performed by a quantum computing system. For example, the system 100 of FIG. 1, appropriately programmed in accordance with this specification, can perform the process 200.

For each of multiple values of a qubit transition frequency and each of multiple amplitudes, the system applies a drive signal with the amplitude and at (e.g., resonant with) the qubit transition frequency to an initialized qubit and measures the qubit to obtain measurement data that represents the qubit state population after application of the drive signal (step 202). The specific range of qubit transition frequency values and amplitude values used depends on the specific technical implementation and can vary. For example, in some implementations the qubit transition frequency can be a 0-1 transition frequency from the ground state to the first excited state and the measurement can correspond to a measurement of the ground state population. In these examples, the multiple values of the qubit transition frequency can be values in the range [5200 MHz, 6000 MHz] and the multiple values of the drive signal amplitude can be values in the range [0.0, 1.0 (a. u)].

The system extracts a minimal amplitude that corresponds to a full population transfer after application of the drive signal from the measurement data and for each qubit transition frequency in a subset of the multiple values of the qubit transition frequency (step 204). For example, continuing the example above, the minimal amplitudes can represent full population transfers from the ground state to the first excited state.

The system fits the minimal amplitudes to a reflection model (step 206). The reflection model is parameterized by reflection model parameters. The reflection model parameters parameterize a standing wave contribution to the drive signal that modifies an effective amplitude of the drive signal incident on the qubit. The reflection model parameters include a reflection amplitude, round-trip reflection time, and phase shift imparted by reflection. The reflection model includes an effective amplitude that results from constructive/destructive interference between the main driving signal and its reflections. Such interference creates a standing-wave pattern of the voltage in the transmission line where the amplitude of the voltage oscillates as a function of the relative phase between the reflected signal and the main driving signal. The relative phase depends on the frequency of the drive signal, and the round trip time of the reflection, and the phase shift at the reflection interface. The magnitude of the voltage oscillation depends on the reflection amplitude. To capture any additional background frequency dependence of the effective drive amplitude (e.g. due to filtering), an additional frequency-dependent factor is included in the reflection model. That is, in some examples the reflection model can be given by Eq. (1), which for convenience is repeated below:

$${Amp}_{π} = ( a + b {f}_{10} + c {f}_{10}^{2} ) \sqrt{1 + {ϵ}^{2} - 2 ϵ cos ( 2 π {f}_{10} {t}_{0} + {ϕ}_{0} )} ,$$

where f₁₀ represents the transition frequency, e represents the reflection amplitude, ϕ₀ represents the phase shift imparted by reflection, to represents the round-trip reflection time, and a+bf₁₀+cf₁₀² represents an additional frequency-dependent factor where parameters a, b, c are fitting parameters in the frequency-dependent factor which is introduced to capture the additional frequency-dependence in the π pulse amplitude (e.g., due to filtering).

To fit the minimal amplitudes to the reflection model, the system can numerically optimize the reflection model parameters using the minimal amplitudes to determine optimal values of the reflection model parameters.

The system inverts a transfer function at the optimal values of the reflection model parameters (step 208). The transfer function represents the impulse response of the signal transmitting channel, for example, a wiring chain that transmits the driving signals (114 in FIG. 1) from control electronics (104 in FIG. 1) to the qubit in the quantum data plane (106 in FIG. 1). The transfer function corresponds to the reflection model. An example frequency-domain transfer function that corresponds to the reflection model in Eq. (1) is given by

$$H ( f ) = \frac{1}{1 - ϵ exp [ i ( {ϕ}_{0} + 2 π f {t}_{0} ) - i 2π {ft}_{0} ]}$$

Here, the additional background frequency dependence (e.g. that due to filtering) is not compensated for, so this transfer function does not depend on parameters a, b, c in Eq. (1). To pre-distort the control pulse, the system multiplies the inverse of the transfer function to the Fourier transform of the control pulse, and applies an inverse Fourier transform to the multiplied inverted transfer function and control pulse to obtain the pre-distorted control pulse in the time domain.

The system pre-distorts one or more control pulses for the qubit using the inverted transfer function (step 210). For example, for a given control pulse, the system can apply a Fourier transform to the control pulse in the time domain and multiply the inverted transfer function in the Fourier domain by the control pulse in the Fourier domain. The system can then apply an inverse Fourier transform to the multiplied inverted transfer function and control pulse to obtain a pre-distorted control pulse in the time domain. The control pulses can include control pulses that implement qubit state rotations about the x axis, y axis, or both the x and y axis.

In some implementations the system can cause application of the pre-distorted control pulses to the qubit (i.e., without storing the pre-distorted one or more control pulses). Alternatively, the system can store the pre-distorted one or more control pulses, e.g., in control electronics memory. For example, the system can perform steps 202-210 described above in advance so that when the system subsequently performs a quantum computation, the control pulses need not be distorted on-the-fly but retrieved from memory and applied to one or more qubits. In some implementations the system can perform steps 202-210 described above each time operating frequencies of a qubit are adjusted, e.g., calibrated to updated values.

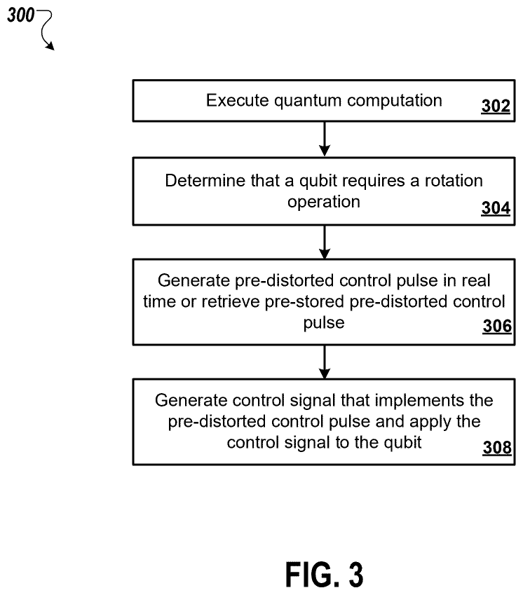

FIG. 3 is a flow diagram of an example process 300 for performing a quantum computation using pre-distorted control pulses. For convenience, the process 300 will be described as being performed by a quantum computing system. For example, the system 100 of FIG. 1, appropriately programmed in accordance with this specification, can perform the process 300.

The quantum computing device executes a quantum computation (step 302). During execution of the quantum computation, the system can determine that a qubit requires a rotation operation, e.g., a rotation about the x and/or y axis (step 304). In response to determining that the qubit requires the rotation operation, the system can either generate a corresponding pre-distorted control pulse in real time (as described above with reference to FIG. 2) or retrieve a pre-stored pre-distorted control pulse (where the pre-distorted control pulse was generated using some or all of the techniques described above with reference to FIG. 2) (step 306). The system can then generate a control signal that implements the pre-distorted control pulse and apply the control signal to the qubit (step 308).

FIG. 4 illustrates an example reflection model analysis and compensation procedure. Illustration a) shows an example circuit diagram. A signal generator 402 drives an impedance Z₁ coupled to a transmission line 404 of characteristic impedance Z₀ that delivers the drive signal to the qubit 406. Due to the impedance mismatch between Z₀ and Z₁, signals incident on that interface will reflect 408 as characterized by the reflection model parameters ϵ, ϕ₀, and t₀.

Illustration b) shows an experimental pulse sequence. A superconducting qubit is initialized in the ground state. A flux bias is applied to the qubit's Z control line 410, setting the transition frequency f₀₁. A variable amplitude microwave drive is then applied at the transition frequency f₀₁ with amplitude A to the XY control line 412, enacting Rabi oscillation. The ground state population is measured using a tone applied to the readout control line 414.

Plot c) shows measured ground state populations p|0 [symbol] versus qubit transition frequency f₁₀ and drive signal amplitude A for a qubit initialized to the ground state. The x-axis of the plot represents qubit transition frequency and ranges from 5200 to 6000 MHz. The y-axis of the plot represents drive signal amplitude and ranges from 0.0 to 1.0 (in arbitrary units). Each square in the plot represents a probability of measuring population in the ground state after application of the drive signal, and ranges from 0 to 1. The line cuts at constant transition frequency exhibit Rabi oscillation. The minimal amplitudes are identified along the line cuts (e.g., the first/lowest minimal amplitude on each line cut). The line of points 416 indicate the extracted minimal amplitudes at each transition frequency value in the subset of transition frequency values. Plot c) corresponds to steps 202 and 204 of example process 200 described above, with reference to FIG. 2.

Plot d) shows the extracted minimal amplitudes fit to the reflection model. Plot d) corresponds to step 206 of example process 200 described above with reference to FIG. 2.

Plot e) shows results of applying the presently described pre-distorted control pulses, e.g., after steps 208 and 210 of example process 200 described above with reference to FIG. 2 have been performed using the parameters determined through the reflection model fits shown in plot d) and the pre-distorted control pulse has been applied to the qubit. In particular, plot e) shows the extracted minimal π pulse amplitude as a function of qubit transition frequency f₁₀ before and after applying the compensation. After the compensation, the magnitude of oscillations in the π pulse amplitude is significantly reduced, meaning the predistortion procedure has significantly compensated the pulse reflections that cause the oscillations in the π pulse amplitude.

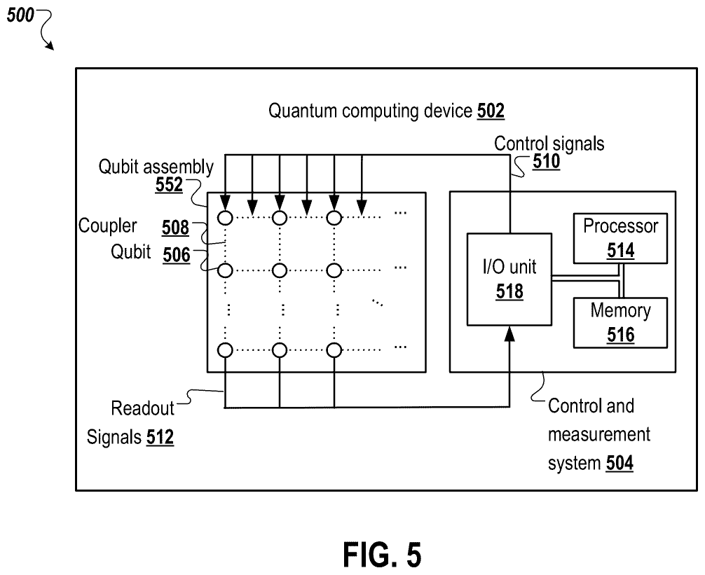

FIG. 5 depicts an example quantum computer 500 for performing the quantum operations described in this specification. The example quantum computer 500 includes an example quantum computing device 502. The quantum computing device 502 is intended to represent various forms of quantum computing devices. The components shown here, their connections and relationships, and their functions, are exemplary only, and do not limit implementations of the inventions described and/or claimed in this document.

The example quantum computing device 502 includes a qubit assembly 552 and a control and measurement system 504. The qubit assembly includes multiple qubits, e.g., qubit 506, that are used to perform algorithmic operations or quantum computations. While the qubits shown in FIG. 5 are arranged in a rectangular array, this is a schematic depiction and is not intended to be limiting. For example, qubits may be configured in alternative arrays or according to different geometries entirely. The qubit assembly 552 also includes adjustable coupling elements, e.g., coupler 508, that allow for interactions between coupled qubits. In the schematic depiction of FIG. 5, each qubit is adjustably coupled to each of its four adjacent qubits by means of respective coupling elements. However, this is an example arrangement of qubits and couplers, and other arrangements are possible, including arrangements that are non-rectangular, arrangements that allow for fixed coupling between some or all qubits, coupling between non-adjacent qubits, and/or arrangements that include (optionally adjustable) coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 502 included in the example computer 500 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits, e.g., superconducting transmon qubits. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement the single qubit rotations about the x axis, y axis, or both the x and y axis described in this specification. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), iSWAP gates, and gates involving three or more qubits, e.g., Toffoli gates. The quantum logic gates can be implemented by applying control signals 510 generated by the control and measurement system 504 to the qubits and to the couplers, where the control signals implement corresponding control pulse/gate sequences.

For example, in some implementations the qubits in the qubit assembly 552 can be frequency tunable. In these examples, each qubit can have associated operating frequencies that can be adjusted through application of voltage pulses via one or more drivelines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 510 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 510. The measurements cause readout signals 512 representing measurement results to be communicated back to the measurement and control system 504. The readout signals 512 may include RF, microwave, or optical signals depending on the physical scheme for the quantum computing device and/or the qubits. For convenience, the control signals 510 and readout signals 512 shown in FIG. 5 are depicted as addressing only selected elements of the qubit assembly (i.e., the top and bottom rows), but during operation the control signals 510 and readout signals 512 can address each element in the qubit assembly 552.

The control and measurement system 504 is an example of a classical computer system that can be used to perform various operations on the qubit assembly 552, as described above, as well as other classical subroutines or computations described herein. The control and measurement system 504 includes one or more classical processors, e.g., classical processor 514, one or more memories, e.g., memory 516, and one or more I/O units, e.g., I/O unit 518, connected by one or more data buses. The control and measurement system 504 can be programmed to send sequences of control signals 510 to the qubit assembly, e.g. to carry out a selected series of quantum gate operations, and to receive sequences of readout signals 512 from the qubit assembly, e.g. as part of performing measurement operations.

The processor 514 is configured to process instructions for execution within the control and measurement system 504. In some implementations, the processor 514 is a single-threaded processor. In other implementations, the processor 514 is a multi-threaded processor. The processor 514 is capable of processing instructions stored in the memory 516.

The memory 516 stores information within the control and measurement system 504, e.g., data specifying pre-distorted control pulses. In some implementations, the memory 516 includes a computer-readable medium, a volatile memory unit, and/or a non-volatile memory unit. In some cases, the memory 516 can include storage devices capable of providing mass storage for the system 504, e.g. a hard disk device, an optical disk device, a storage device that is shared over a network by multiple computing devices (e.g., a cloud storage device), and/or some other large capacity storage device.

The input/output device 518 provides input/output operations for the control and measurement system 504. The input/output device 518 can include D/A converters, A/D converters, and RF/microwave/optical signal generators, transmitters, and receivers, whereby to send control signals 510 to and receive readout signals 512 from the qubit assembly, as appropriate for the physical scheme for the quantum computer. In some implementations, the input/output device 518 can also include one or more network interface devices, e.g., an Ethernet card, a serial communication device, e.g., an RS-232 port, and/or a wireless interface device, e.g., an 802.11 card. In some implementations, the input/output device 518 can include driver devices configured to receive input data and send output data to other external devices, e.g., keyboard, printer, and display devices.

Although an example control and measurement system 504 has been depicted in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a quantum computing device, the method comprising:
for each of multiple values of a qubit transition frequency:
applying, for each of multiple amplitudes and at the transition frequency, a drive signal with the amplitude to an initialized qubit; and
measuring the qubit to obtain measurement data that represents qubit state population after application of the drive signal;
extracting, from the measurement data and for each qubit transition frequency in a subset of the multiple values of the qubit transition frequency, a minimal amplitude that corresponds to a full population transfer after application of the drive signal;
determining values of parameters of a reflection model to fit the minimal amplitudes to the reflection model, wherein the parameters of the reflection model parameterize a standing wave contribution to the drive signal that modifies an effective amplitude of the drive signal incident on the qubit;
inverting a transfer function at the determined values of the parameters of the reflection model, wherein the transfer function corresponds to the reflection model; and
pre-distorting one or more control pulses for the qubit using the inverted transfer function.

2. The method of claim 1, wherein the parameters of the reflection model comprise a reflection amplitude, round-trip reflection time, and phase shift imparted by reflection.

3. The method of claim 1, wherein the reflection model comprises an effective amplitude that represents constructive-destructive interference between the drive signal and reflections of the drive signal, wherein the interference creates a standing-wave pattern of voltage in a corresponding transmission line.

4. The method of claim 1, wherein the reflection model Amp_{π} is given by
$${Amp}_{π} = ( a + b f + c {f}^{2} ) \sqrt{1 + {ϵ}^{2} - 2 ϵ cos ( 2 π {ft}_{0} + {ϕ}_{0} )}$$
where ϵ represents a reflection amplitude, ϕ₀ represents a phase shift imparted by reflection, t₀ represents round-trip reflection time, f represents transition frequency, a+bf+cf² represents a frequency-dependent factor where parameters a, b, c are fitting parameters in the frequency-dependent factor introduced to capture an additional frequency-dependence in the drive signal amplitude.

5. The method of claim 1, wherein the transition frequency comprises a transition frequency from a ground state to a first excited state and the minimal amplitudes represent a full population transfer from the ground state to the first excited state.

6. The method of claim 1, wherein determining values of parameters of the reflection model comprises numerically optimizing the values of parameters of the reflection model using the minimal amplitudes.

7. The method of claim 1, further comprising applying the pre-distorted control pulses to the qubit during a quantum computation.

8. The method of claim 1, wherein the one or more control pulses comprise control pulses that implement rotations about the x axis, y axis, or both the x and y axis.

9. The method of claim 1, wherein inverting the transfer function at the determined values of the parameters of the reflection model comprises inverting the transfer function in the Fourier domain.

10. The method of claim 9, wherein pre-distorting a control pulse for the qubit comprises:
multiplying the inverted transfer function in the Fourier domain by a Fourier transform of the control pulse; and
applying an inverse Fourier transform to obtain a pre-distorted control pulse in the time domain.

11. The method of claim 1, wherein the qubit comprises a transmon qubit and one or more of:
the qubit is set to the transition frequency prior to application of the drive signal using a flux bias of a SQUID loop of the transmon qubit;
applying the drive signal with the amplitude to the initialized qubit comprises applying the drive signal with the amplitude to a XY control line of the transmon qubit at the transition frequency; and
measuring the qubit comprises measuring the ground state population of the transmon qubit with a tone applied to a readout control line of the transmon qubit.

12. A quantum computing device comprising:
one or more qubits;
control electronics configured to apply control signals to the one or more qubits; and
a classical processor configured to process instructions for execution by the control electronics;
wherein the quantum computing device is configured to perform operations comprising:
for each of multiple values of a qubit transition frequency:
applying, for each of multiple amplitudes and at the transition frequency, a drive signal with the amplitude to an initialized qubit; and
measuring the qubit to obtain measurement data that represents qubit state population after application of the drive signal;
extracting, from the measurement data and for each qubit transition frequency in a subset of the multiple values of the qubit transition frequency, a minimal amplitude that corresponds to a full population transfer after application of the drive signal;
determining values of parameters of a reflection model to fit the minimal amplitudes to the reflection model, wherein the parameters of the reflection model parameterize a standing wave contribution to the drive signal that modifies an effective amplitude of the drive signal incident on the qubit;
inverting a transfer function at the determined values of the parameters of the reflection model, wherein the transfer function corresponds to the reflection model; and
pre-distorting one or more control pulses for the qubit using the inverted transfer function.

13. A method performed by a quantum computing device, the method comprising:
generating a pre-distorted control signal that implements a single qubit rotation operation; and
applying the pre-distorted control signal to a qubit to perform the rotation operation on the qubit, the pre-distorted control signal comprising an inverted transfer function, wherein:
the inverted transfer function comprises values of parameters obtained through fitting control pulse amplitudes that implement a full qubit population transfer to a reflection model with reflection model parameters that parameterize a standing wave contribution to the control signal that modifies an effective amplitude of control pulses incident on the qubit.

14. The method of claim 13, wherein the parameters of the reflection model comprise a reflection amplitude, round-trip reflection time, and phase shift imparted by reflection.

15. The method of claim 13, wherein the reflection model comprises an effective amplitude that represents constructive-destructive interference between the drive signal and reflections of the drive signal, wherein the interference creates a standing-wave pattern of voltage in a corresponding transmission line.

16. The method of claim 13, wherein the reflection model Amp_{π} is given by
$${Amp}_{π} = ( a + b f + c {f}^{2} ) \sqrt{1 + {ϵ}^{2} - 2 ϵ cos ( 2 {π ft}_{0} + {ϕ}_{0} )}$$
where ϵ represents a reflection amplitude, ϕ₀ represents a phase shift imparted by reflection, t₀ represents round-trip reflection time, f represents transition frequency, a+bf+cf² represents a frequency-dependent factor where parameters a, b, c are fitting parameters in the frequency-dependent factor introduced to capture an additional frequency-dependence in the drive signal amplitude.

17. The method of claim 13, wherein the control pulse amplitudes that implement a full qubit population transfer comprise minimal amplitudes of a drive signal that, when applied to the qubit at respective qubit transition frequencies, implements a full qubit population transfer.

18. A quantum computing device comprising:
one or more qubits;
control electronics configured to apply control signals to the one or more qubits; and
a classical processor configured to process instructions for execution by the control electronics;
wherein the quantum computing device is configured to perform operations comprising:
generating a pre-distorted control signal that implements a single qubit rotation operation; and
applying the pre-distorted control signal to a qubit to perform the rotation operation on the qubit, the pre-distorted control signal comprising an inverted transfer function, wherein:
the inverted transfer function comprises values of parameters obtained through fitting control pulse amplitudes that implement a full qubit population transfer to a reflection model with reflection model parameters that parameterize a standing wave contribution to the control signal that modifies an effective amplitude of control pulses incident on the qubit.
